(19) United States
(12) Patent Application Publication
(10) Pub. No.: US 2026/0364604 A1
(43) Pub. Date: Nov. 19, 2026

(54) UPRIGHT MILL CONE LINER

(71) Applicant: SAS GLOBAL CORPORATION, Warren, MI (US)

(72) Inventors: David A. BILLINGS, Jr., Mancelona, MI (US); Alec Mark RATCLIFFE, Walled Lake, MI (US); Justin James Paul BENNETT, Novi, MI (US); Kevin Raymond KLEIST, Macomb, MI (US)

(21) Appl. No.: 19/677,490

(22) Filed: May 14, 2026

Related U.S. Application Data
(60) Provisional application No. 63/806,361, filed on May 15, 2025.

(51) Int. Cl. B02C 2/00

(52) U.S. Cl. CPC B02C 2/005

(57) ABSTRACT

An upright mill cone assembly is provided with a first retainer array attached to a surface of an upright mill cone. A first plate assembly is provided with a plate sized to cover a portion of the upright mill cone. A second retainer is provided to attach the plate to the first retainer array, wherein upon installation to the first retainer array, the plate has a limited range of movement relative to the first retainer array, and wherein, when more than one of the plurality of plate assemblies is installed to the first retainer array, one of the plate assemblies is prohibited from movement in the limited range of movement, and thereby prohibited from removal from the first retainer array. A plate assembly, a retainer array, a method to assemble, and a method to disassemble are also provided therefor.

### CROSS-REFERENCE TO RELATED APPLICATIONS

This application claims the benefit of U.S. provisional Application No. 63/806,361 filed May 15, 2025, the disclosure of which is incorporated in its entirety by reference herein.

### TECHNICAL FIELD

Various embodiments relate to upright mill cones, and liners therefor.

### BACKGROUND

Upright or vertical mills used in cement, mineral, and similar material-processing industries commonly include an upright mill cone positioned within a milling chamber to guide particulate material and airflow during operation. Surfaces of the upright mill cone are exposed to highly abrasive and erosive conditions caused by particulate material entrained in forced air streams, resulting in substantial wear over time.

### SUMMARY

According to at least one embodiment, a plate assembly is provided with a plate sized to cover a portion of an upright mill cone and a retainer to attach the plate to the upright mill cone. Upon installation to the upright mill cone, the plate has a limited range of movement relative to the upright mill cone. When a plurality of plate assemblies is installed to the upright mill cone, one of the plurality of plate assemblies is prohibited from movement in the limited range of movement, and is thereby prohibited from removal from the upright mill cone.

According to further embodiments, the plate is provided with a hardened exterior surface to resist abrasion from particulate material within the upright mill.

According to further embodiments, the hardened exterior surface is provided with a carbide overlay.

According to further embodiments, the plate is formed from steel.

According to further embodiments, the plate is sized to not exceed a predetermined weight to permit manual installation.

According to further embodiments, the predetermined weight is fifty pounds or less.

According to further embodiments, the predetermined weight is one hundred pounds or less.

According to further embodiments, the retainer is provided with at least one hook extending from a rear surface of the plate.

According to further embodiments, the retainer is provided with a plurality of hooks oriented downward.

According to further embodiments, the plurality of hooks is provided with leading edges angled to slide along a rung during installation.

According to further embodiments, the limited range of movement is an upright lifting movement.

According to further embodiments, the plate assembly is retained in position by gravity during operation.

According to further embodiments, the plate is flat and forms a radial segment of a frustoconical liner assembly.

According to further embodiments, the plate is curved to form part of a frustoconical liner assembly.

According to further embodiments, the retainer is welded to the plate.

According to further embodiments, the retainer cooperates with a rung to limit motion to a single direction.

According to further embodiments, an upright mill cone assembly is provided with an upright mill cone, a first retainer array attached to a surface of the upright mill cone, and a plurality of the plate assemblies. Each plate assembly is provided with a plate and a plate retainer operable to attach the plate to the first retainer array. Upon installation to the first retainer array, each plate has a limited range of movement relative to the first retainer array. When more than one of the plurality of plate assemblies is installed to the first retainer array, one of the plate assemblies is prohibited from movement in the limited range of movement, and is thereby prohibited from removal from the first retainer array.

According to at least one embodiment, a first retainer array is provided and is sized to be attached to a surface of an upright mill cone. The first retainer array is sized to receive a plate retainer of a plurality of plate assemblies. Upon installation of the plurality of plate assemblies to the first retainer array, a first plate assembly has a limited range of movement relative to the first retainer array. When more than one of the plurality of plate assemblies is installed to the first retainer array, the first plate assembly is prohibited from movement in the limited range of movement, and is thereby prohibited from removal from the first retainer array.

According to further embodiments, the first retainer array is further provided with a plurality of elongate rails extending along a tapered surface.

According to further embodiments, the rails diverge toward an upper opening of the upright mill cone and converge toward a lower outlet.

According to further embodiments, the rails are operable to be welded to the upright mill cone.

According to further embodiments, the first retainer array is further provided with rungs extending between pairs of rails.

According to further embodiments, the rungs are angled outward relative to the cone surface.

According to further embodiments, the rails are grouped into pairs separated by a first angular spacing.

According to further embodiments, adjacent pairs of rails are separated by a second angular spacing smaller than the first angular spacing.

According to further embodiments, each rung is sized to support at least two hooks of a plate assembly.

According to further embodiments, the first retainer array is further provided with a bracket positioned near an upper end of the retainer array.

According to further embodiments, the first retainer array is further provided with a fastener supported upon the bracket to extend over an uppermost plate assembly.

According to further embodiments, the fastener is positioned to be outside the plate assemblies.

According to further embodiments, the fastener is positioned to block upward movement of the uppermost plate assembly.

According to further embodiments, removal of the fastener permits sequential removal of plate assemblies from top to bottom.

According to further embodiments, an upright mill cone assembly is provided with an upright mill cone, the first retainer array attached to the surface of the upright mill cone, and a plurality of plate assemblies. A first plate assembly of the plurality of plate assemblies is provided with a plate sized to cover a portion of the upright mill cone and a second retainer to attach the plate to the first retainer array. Upon installation to the first retainer array, the plate has a limited range of movement relative to the first retainer array. When more than one of the plurality of plate assemblies is installed to the first retainer array, one of the plate assemblies is prohibited from movement in the limited range of movement, and is thereby prohibited from removal from the first retainer array.

According to at least one embodiment, an upright mill cone assembly is provided with an upright mill cone, a first retainer array attached to a surface of the upright mill cone, and a plurality of plate assemblies. A first plate assembly of the plurality of plate assemblies is provided with a plate sized to cover a portion of the upright mill cone and a second retainer to attach the plate to the first retainer array. Upon installation to the first retainer array, the plate has a limited range of movement relative to the first retainer array. When more than one of the plurality of plate assemblies is installed to the first retainer array, one of the plate assemblies is prohibited from movement in the limited range of movement, and is thereby prohibited from removal from the first retainer array.

According to further embodiments, the first plate assembly is blocked from removal by a second plate assembly positioned above the first plate assembly.

According to further embodiments, adjacent plate assemblies abut one another.

According to further embodiments, adjacent plate assemblies overlap in a shingle arrangement.

According to at least one embodiment, a method to assemble an upright mill cone is provided. The method includes installing a plate assembly on the upright mill cone by moving the plate assembly in a limited range of movement relative to the upright mill cone. The method further includes installing an obstacle to the upright mill cone outside the plate assembly and within the limited range of movement to prevent movement of the plate assembly relative to the upright mill cone, and consequently to prevent removal of the plate assembly from the upright mill cone.

According to further embodiments, the method further includes sliding hooks of the plate assembly onto rungs on the upright mill cone.

According to further embodiments, the method further includes installing a plurality of plate assemblies in a sequence from the bottom and upward.

According to further embodiments, the method further includes blocking upward movement of the plate assembly by installing a subsequent plate assembly.

According to further embodiments, the method further includes installing an external fastener as the obstacle to the plate assembly.

According to at least one embodiment, a method of disassembling an upright mill cone is provided. The method includes removing an obstacle from the upright mill cone outside a plate assembly to permit movement of the plate assembly in a limited range of motion relative to the upright mill cone, and consequently to permit removal of the plate assembly from the upright mill cone. The method further includes removing the plate assembly from the upright mill cone by moving the plate assembly in the limited range of movement.

According to further embodiments, the method further includes removing an external fastener to remove the obstacle.

According to further embodiments, the method further includes removing an uppermost plate assembly of a plurality of plate assemblies.

According to further embodiments, the method further includes subsequently removing a sequentially downward plate assembly of the plurality of plate assemblies.

According to further embodiments, the method further includes lifting the plate assembly within the limited range of motion.

### BRIEF DESCRIPTION OF THE DRAWINGS

FIG. 1 is a perspective view of an upright mill, often referred to as a vertical mill, according to an embodiment;

FIG. 2 is a front perspective view of a cone assembly of the vertical mill of FIG. 1, according to an embodiment, illustrated partially assembled with a first retainer array;

FIG. 3 is a partially exploded front perspective view of the cone assembly of FIG. 2, illustrated partially assembled with a plurality of plate assemblies;

FIG. 4 is a partially exploded rear perspective view of the first retainer array of FIG. 2 and a subset of the plurality of plate assemblies of FIG. 3;

FIG. 5 is a front perspective view of the cone of FIG. 2, illustrated partially assembled;

FIG. 6 is a front perspective view of one of the plurality of plate assemblies of FIG. 3;

FIG. 7 is a rear perspective view of the plate assembly of FIG. 6;

FIG. 8 is a side perspective view of the plate assembly of FIG. 6;

FIG. 9 is a side elevation view of a cone assembly of the vertical mill of FIG. 1, according to an embodiment;

FIG. 10 is an enlarged partial section view taken along section line 10 -10 in FIG. 9;

FIG. 11 is a side perspective view of a cone assembly of the vertical mill of FIG. 1, according to another embodiment;

FIG. 12 is an enlarged partial section view taken along section line 12 -12 in FIG. 11;

FIG. 13 is a flowchart of a method to assemble a vertical mill cone, according to an embodiment; and

FIG. 14 is a flowchart of a method to disassemble a vertical mill cone, according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc., are, in some instances, used herein to describe various elements, these elements should not be limited by these terms. These terms are only used to distinguish one element from another and are presented in order of introduction for a particular embodiment, and may vary in the introduction of various embodiments. For example, a first retainer could be termed a second retainer, and, similarly, a second retainer could be termed a first retainer, without departing from the scope of the various described embodiments. The first retainer and the second retainer are both retainers, but they are not the same retainer in the context of a particular embodiment.

A vertical raw mill is a type of grinder used to grind materials into a finer particle size or powder. Vertical raw mills are employed in cements, mineral dressing processes, paints, pyrotechnics, ceramics, raw material, cement clinker, slag, coal slag, and other suitable ground materials.

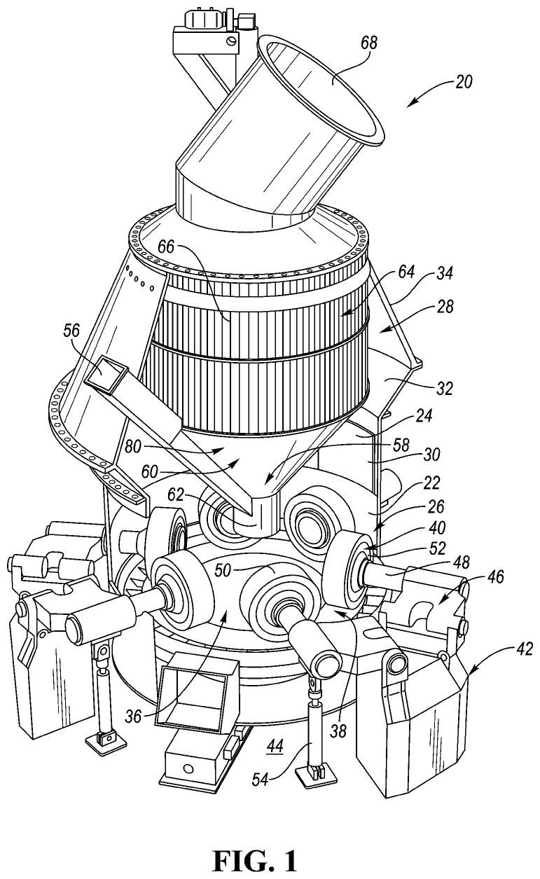

FIG. 1 illustrates an upright raw mill 20, referred to as a vertical raw mill 20, according to an embodiment. According to the depicted embodiment, the vertical raw mill 20 is a roller mill for milling material powders for cement manufacturing. Although a roller mill 20 is depicted, and described, any vertical mill may be utilized, such as a ball mill, or any suitable crusher, grinder, or the like. Vertical roller mills 20 are an energy efficient alternative to a ball mill. Vertical roller mills 20 have a simplified and compact structure, with reasonable manufacturing and maintenance costs.

As illustrated in FIG. 1, the mill 20 includes a mill casing 22, with an internal chamber 24 to enclose a milling operation. The mill casing 22 includes a milling zone 26 and a separation zone 28. The milling zone 26 is generally cylindrical. The separation zone 28 is also generally cylindrical at a lower zone 30 as it extends away from the milling zone 26, and then enlarges outward in a first frustoconical region 32, and then tapers inward in a second frustoconical region 34. The mill casing 22 may form any suitable shape to enclose the milling operation and provide a relatively compact footprint. The zones 26, 28 and regions 30, 32, 34 are merely descriptions of those common with conventional vertical raw mills 20, and in no way limit the applicability of other features described herein.

The mill 20 includes a grind table 36 oriented at a lower end within the milling zone 26 of the mill casing 22. The grind table 36 is driven for rotation by a powertrain assembly (not shown) which may include a motor, transmission, gear box, clutch, and the like. The grind table 36 is rotated about a vertical axis. The grind table 36 includes a track 38 for performing the milling operation.

The mill 20 includes a plurality of roller assemblies 40 to cooperate with the grind table 36 to provide the milling operation. Each roller assembly 40 is supported by a support base 42 located externally of the mill casing 22. The support bases 42 are supported upon an underlying support surface 44, such as the ground, floor, or the like. Each roller assembly 40 may include a rocker arm 46 pivotally supported by one of the support bases 42. A roller shaft 48 extends from each rocker arm 46, through the milling zone 26 of the mill casing 22, and into the mill chamber 24.

Each roller assembly 40 also includes a roller 50 mounted upon a bearing assembly 52 on a distal end of the shaft 48. Each roller 50 engages the track 38 roll along the track 38 as the grind table 36 is rotated. Each roller assembly 40 may also include a suspension assembly 54 supported upon the ground 44 and connected to the rocker arm 46 to absorb, return, and/or dissipate movement and forces upon the rocker arm 46 as the rocker arm 46 pivots relative to the support base 42. The weight of the rollers 50 maintains the rollers 50 in contact with track 38 to roll along the track 38. The pivotability of the rocker arms 46 permit the rollers 50 to move upward and away from the track 38 to travel over material upon the track 38.

As the grind table 36 is rotated, materials placed on the grind table 36 move centrifugally outward to the track 38, and are imposed by an external grinding operation between the rollers 50 and the track 38. The weight of the rollers 50 provides vertical pressure upon the track 38 and onto any material upon the track 38 to crush and/or shear the material.

The mill 20 includes a feed chute 56 extending through the mill casing 22 for intake of material into the chamber 24. The chute 56 is oriented above the milling zone 26 and feeds the material into a central region of the milling zone 26 to be deposited onto the grind table 36. The mill 20 also includes a cone assembly 58, located generally central within the chamber 24. The cone assembly 58 is illustrated as a cone-shaped assembly 58. Of course, any suitable geometry may be employed by the cone assembly 58 to funnel material. Regardless of geometry, the funnel-shaped cone assembly 58 is often referred to as a cone in the art and may take any shape suitable in a vertical mill operation. The feed chute 56 may be provided externally along the cone assembly 58.

The cone assembly 58 is a steel assembly or weldment, and includes a generally frustoconical shaped portion 60 that tapers inward and extends downward from the first frustoconical region 32 to the cylindrical region 30 of the separation zone 28. A cylindrical outlet 62 extends downward from a distal end of the cone portion 60 further into the cylindrical region 30 of the separation zone 28 and into the milling zone 26. The cone assembly 58 may be embodied by any geometry, cone-shaped or the like, that converges toward the outlet 62.

During the milling operation, a fluid, such as air, is forced vertically in an upright direction through the casing chamber 24. For dry milling, the forced fluid may be heated. The forced air is introduced in the milling zone 26 and may pass through and/or around the grind table 36. Particles of the grinded material are entrained in the forced air and pass around the cone assembly 58 from the cylindrical region 30, to the frustoconical regions 32, 34.

A separator/classifier 64 is oriented above an enlarged end of the frustoconical portion 60 of the cone assembly 58 within the frustoconical regions 32, 34. The separator/classifier 64 includes a cage rotor 66 that is rotated within the chamber 24. As the air is forced around the cone assembly 58, the forced air enters the separator/classifier 64. The separator/classifier 64 is designed and tuned so that particles of a specific size are conveyed out of an outlet 68 in an upper end of the casing 22. Particles that exceed the permissible size limit are redirected by the separator/classifier 64 into the cone assembly 58 and funneled to the cone outlet 62. The oversized particles are then dropped onto the grind table 36 to be reground.

The grinding operation is generally abrasive and erosive and causes significant wear to the track 38 and rollers 50. During production of a raw mix for cement, abrasive materials such as limestone and silica are ground in the mill 20. Often the raw mix is mixed with clay, heated to produce clinker, and then reground to create cement powder. The track 38 and rollers 50 are commonly manufactured from a steel material with hardened surfaces to resist abrasion and wear. Over time, these components 38, 50 require maintenance repair or replacement due to the wear and abrasion.

Other surfaces within the mill 20 are often coated or lined with hardened surfaces to resist abrasion from particulate matter within the forced air. For example, the exterior surface of the cone assemblies is often coated or lined with a hardened material. One prior art option includes hardened plates that are welded to the exterior of the cone assembly. However, repair or replacement of the cone assembly includes welding of the hardened plates, thereby adding significant cost and down time of equipment for maintaining the associated mill. Another prior art option includes hardened plates that are fastened to the exterior of the cone assembly. However, the fasteners are also subjected to the abrasion thereby creating difficulties in removing worn fasteners.

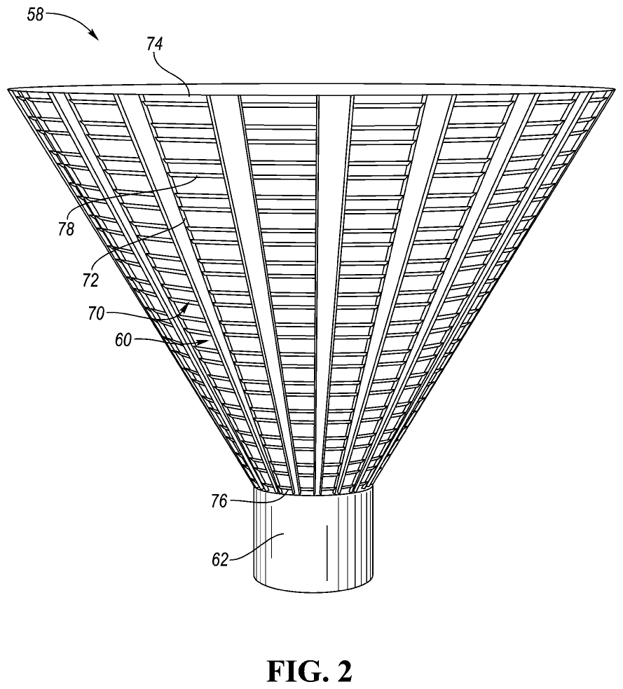

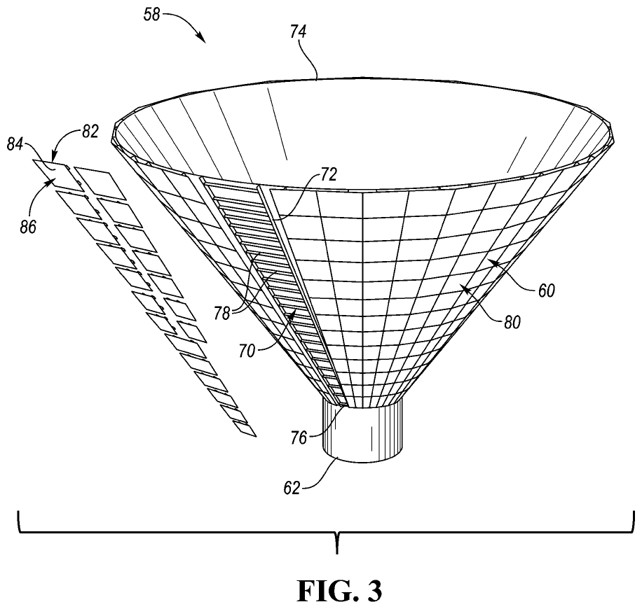

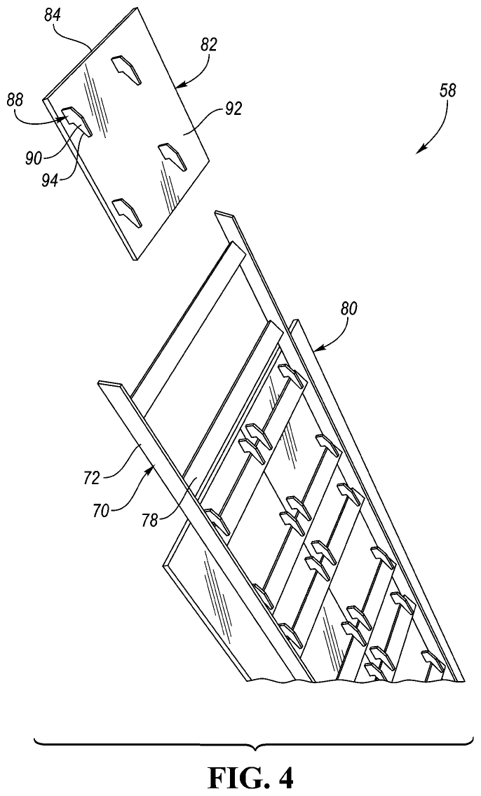

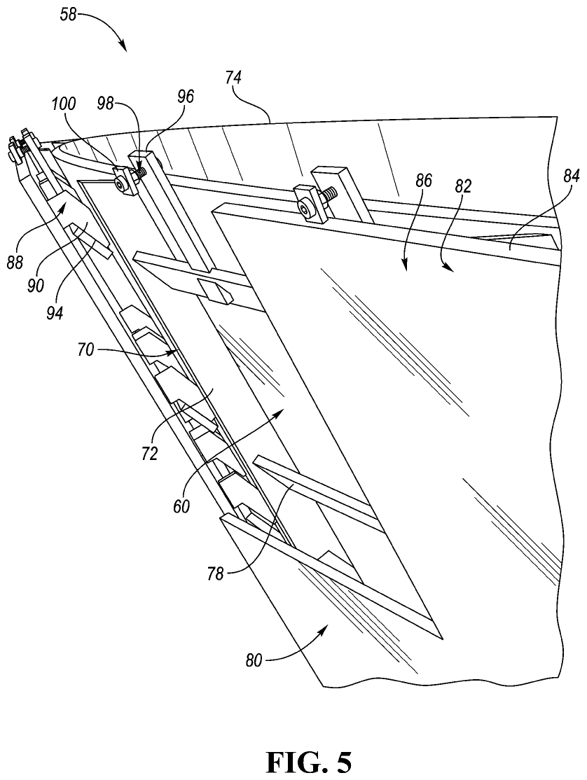

FIGS. 2 and 3 illustrate the cone assembly 58 partially assembled. The cone assembly 58 includes a first retainer array 70, or a first fastener array 70, for attaching a liner assembly. The first retainer array 70 is oriented in a radial array around the frustoconical portion 60. The first retainer array 70 is illustrated in enlarged detail in FIGS. 4 and 5. Referring now to FIGS. 2-5, the first retainer array 70 includes an array of elongate rails 72 provided around an exterior surface of the frustoconical portion 60. The rails 72 may be formed from a stock steel material that is welded to the cone assembly 58. The rails 72 extend from an enlarged opening 74 to an intersection 76 of the frustoconical portion 60 with the outlet 62. Likewise, the rails 72 diverge to the opening 74, and converge toward the intersection 76.

The rails 72 are spaced about the exterior of the frustoconical portion 60 intermittently. The rails 72 may include an alternating spacing with varying widths. The rails 72 each include a common width, depth, and length. A first angular spacing between the rails 72 groups the rails 72 into pairs. A series of rungs 78 is oriented in the first angular spacing between each pair of rails 72. Each pair of rails 72 is spaced apart from a sequential pair of rails 72 by a second angular spacing, which is less than the first angular spacing, and may be provided without rungs 78. The rungs 78 may also be formed from a stock steel material. The rungs 78 may also be welded to the cone assembly 58, and to the rails 72. The rungs 78 have a length extending between the corresponding pair of rails 72. With reference now to FIGS. 4 and 5, the rungs 78 also have a stock width angled in an upright direction and away from the frustoconical portion with a stock thickness facing upright and outward. The array of first retainers 70 provide an appearance and similarity to an array for tapered ladders. Various retainer arrangements may be employed for attaching components to the cone assembly 58.

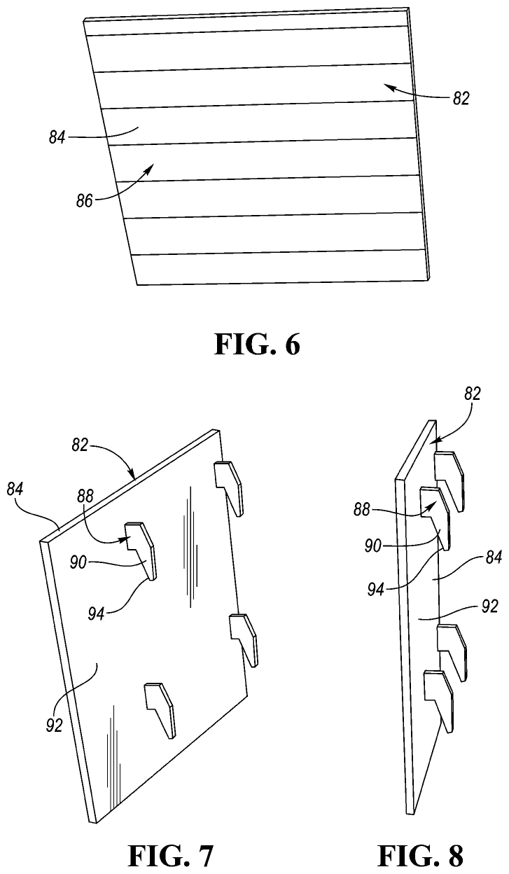

Now with reference to FIGS. 3-5, the cone assembly 58 is illustrated with a liner assembly 80. The liner assembly 80 is affixed to the first retainer array 70 to line the exterior of the cone assembly 58 to conceal the cone assembly 58 and protect the cone assembly 58 from abrasion from the particulates passed over the cone assembly 58 during the milling operation. According to the depicted embodiment, the liner assembly 80 is provided by a plurality of plate assemblies 82. FIG. 3 illustrates the cone assembly 58 with the plate assemblies 82 attached to the first retainer array 70, except at the rungs 78 on one pair of rails 72. FIG. 4 illustrates the first retainer array 70 with the frustoconical portion 60 removed to reveal an engagement of the plate assemblies 82 with the rungs 78. The plate assemblies 82 are illustrated enlarged and in greater detail in FIGS. 6-8.

Referring now to FIGS. 3-8, the plate assemblies 82 each include a plate 84. The plate 84 is formed from a steel material. The plate 84 may be flat as depicted thereby collectively providing a funnel shaped liner assembly 80 with flat radial segments. The flatness of the plate 84 may be due to a stock material, and may be flat within typical manufacturing tolerances. According to another embodiment, the plates 84 are curved to collectively provide a frustoconical liner assembly 80.

Each plate 84 is sized to cover an exterior portion of the frustoconical portion 60 of the cone assembly 58. As illustrated in FIG. 6, an exterior surface 86 of each plate 84 is created with a hardened surface 86 to withstand the abrasion during the milling process. According to an embodiment, the hardened surface is a carbide overlay plate. The hardened surface 86 is illustrated as surface weld applied to the exterior surface 86. Alternatively, the hardened surface 86 may be lined, coated, plated, or otherwise applied to the hardened surface 86. According to another embodiment, the plate 84 may be formed as a ceramic tile or another hardened material, such as alloy wear steel.

With reference again to FIGS. 3-8, each plate 84 is sized to not exceed a predetermined weight. By minimizing the weight of the plates 84, the plate assemblies 82 may be efficiently, safely, and ergonomically installed, removed, and repaired. According to one example, the plates 84 are sized to not exceed fifty pounds. In other embodiments, the plates 84 may be sized to weigh up to one hundred pounds while remaining manually installable.

As illustrated in FIGS. 4, 5, 7, and 8, each plate assembly 82 includes a second retainer array 88 for attaching each plate assembly 82 onto the first retainer array 70. According to an embodiment, the second retainer array 88 includes a plurality of hooks 90 provided extending from a rear surface 92 of the plate 84. The hooks 90 may be formed from stock steel and welded to the plates 84. The hooks 90 are each pointed downward to hook upon one of the rungs 78 of the first fastener array 70. According to one embodiment, the hooks 90 are also provided in an array of four hooks 90 spaced apart so that each pair of hooks 90 is hung on one rung 78. While hooks 90 and rungs 78 are illustrated and described, other cooperative geometries including slots, dovetails, pins, or rails may be utilized.

The hooks 90 are each formed with a leading edge 94 to engage the rungs 78. The rungs 78 and the leading edges 94 are angled so that during installation, the hooks 90 are slid along the rungs 78, while translating the plate 84 toward the rails 72. Once each plate assembly 82 is slid fully downward, the plate assembly 82 is retained in position and only movable in one direction, by lifting the plate assembly 82 along the leading edge 94. In other words, once a plate assembly 82 is installed, the plate assembly 82 has a limited range of movement relative to the first retainer array 70, and can only be moved by lifting the plate assembly 82. During installation, each plate assembly 82 is held in position by gravity.

As illustrated in FIG. 4, each plate assembly 82 is blocked from upward movement, and consequently blocked from removal, by installation of a subsequent sequential plate assembly 82 above the installed plate assembly 82. Once a plate assembly 82 is installed, it blocks the limited range of movement of the plate assembly 82 below it. By blocking a previously installed plate assembly 82, each installed plate assembly 82 provides an obstacle that locks a previous plate assembly 82 for locked retention upon the cone assembly 58, thereby prohibiting inadvertent removal of each previously installed plate assembly 82. The plate assemblies 82 may cooperate by abutment of edges of the plates 84 as illustrated in FIGS. 3-5. Alternatively, each plate 84 may overlap a sequential plate 84 in a shingle arrangement.

As illustrated in FIG. 5, each plate assembly 82 blocks a lower plate assembly 82 from removal. A pair of brackets 96 are welded to each upper rung 78 to extend above the uppermost plate assembly 82. A fastener assembly 98, such as a bolt 98, is threaded into each bracket 96 to extend from the bracket 96, and over the uppermost plate assembly 82. A block 100 is fastened upon the bolt 98 and positioned above, and in engagement with an upper edge of the upper plate 84. The block 100 provides an obstacle to limit movement of the upper plate assembly 82, thereby securing the upper plate assembly 82 in position. The block 100 retains the upper plate assembly 82, and consequently, the sequential lower plate assemblies 82 from inadvertent removal, which may be caused by forced air or vibrations during the milling operation. In some embodiments, the obstacle blocking removal may be another plate assembly, a fastener, a block, or any combination thereof.

The block 100 and bolt 98 are outside the plate assembly 84. Therefore, abrasion of the fastener assembly 98 may lead to replacement of one fastener assembly 98 per row of plate assemblies 82, as opposed to one or more fastener assembly per plate assembly. Further, by positioning the fastener assembly 98 outside of the plate assemblies 84, the fastener assembly 98 is accessible for repair or replacement.

In order to disassemble the liner assembly 80, the fastener assemblies 98 are removed, and then the plate assemblies 82 are lifted and removed sequentially from the top.

The liner assembly 80 permits ease and efficiency for installation and maintenance. The liner assembly 80 eliminates the step of welding liners to the cone assembly.

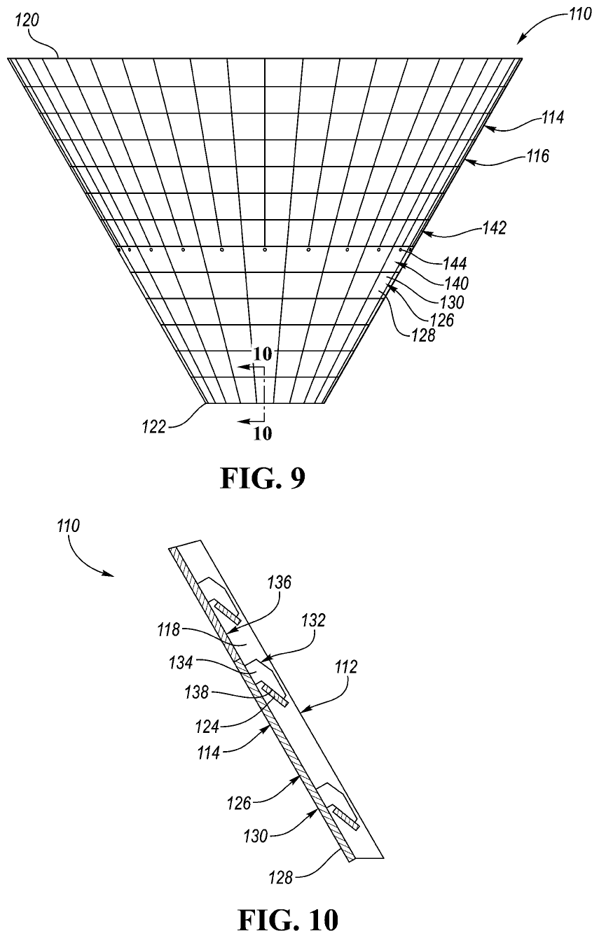

FIGS. 9 and 10 illustrate a cone assembly 110 according to at least one embodiment. With reference now to FIG. 10, the cone assembly 110 includes a first retainer array 112 for attaching a liner assembly 114. The first retainer array 112 is oriented in a radial array around a frustoconical portion 116. The first retainer array 112 includes an array of elongate rails 118 provided around an exterior surface of the frustoconical portion 116, similar to the prior embodiment. The rails 118 may be formed from a stock steel material that is welded to the cone assembly 110. The rails 118 extend from an enlarged opening 120 to an intersection 122 of the frustoconical portion 116 with the outlet 62. Likewise, the rails 118 diverge to the opening 120, and converge toward the intersection 122.

The rails 118 are spaced about the exterior of the frustoconical portion 116 intermittently. The rails 118 may include an alternating spacing with varying widths. The rails 118 each include a common width, depth, and length. A first angular spacing between the rails 118 groups the rails 118 into pairs. A series of rungs 124 is oriented in the first angular spacing between each pair of rails 118. Each pair of rails 118 is spaced apart from a sequential pair of rails 118 by a second angular spacing, which is less than the first angular spacing, and may be provided without rungs 124. The rungs 124 may also be formed from a stock steel material. The rungs 124 may also be welded to the cone assembly 110, and to the rails 118. The rungs 124 have a length extending between the corresponding pair of rails 118. The rungs 124 also have a stock width angled in an upright direction and away from the frustoconical portion 116 with a stock thickness facing upright and outward. The array of first retainers 112 provide an appearance and similarity to an array for tapered ladders. Various retainer arrangements may be employed for attaching components to the cone assembly 110.

Now with reference again to FIGS. 9 and 10, the cone assembly 110 is illustrated with the liner assembly 114. The liner assembly 114 is affixed to the first retainer array 112 to line the exterior of the cone assembly 110 to conceal the cone assembly 110 and protect the cone assembly 110 from abrasion from the particulates passed over the cone assembly 110 during the milling operation. According to the depicted embodiment, the liner assembly 114 is provided by a plurality of plate assemblies 126.

The plate assemblies 126 each include a plate 128. The plate 128 is formed from a steel material. The plate 128 may be flat as depicted thereby collectively providing a funnel shaped liner assembly 114 with flat radial segments. According to another embodiment, the plates 128 are curved to collectively provide a frustoconical liner assembly 114.

Each plate 128 is sized to cover an exterior portion of the frustoconical portion 116 of the cone assembly 110. An exterior surface 130 of each plate 128 is created with a hardened surface 130 to withstand the abrasion during the milling process. According to an embodiment, the hardened surface is a carbide overlay plate. The hardened surface 130 may include a surface weld applied to the exterior surface 130. Alternatively, the hardened surface 130 may be lined, coated, plated, or otherwise applied to the hardened surface 130. According to another embodiment, the plate 128 may be formed as a ceramic tile or another hardened material, such as alloy wear steel.

Each plate 128 is sized to not exceed a predetermined weight. By minimizing the weight of the plates 128, the plate assemblies 126 may be efficiently, safely, and ergonomically installed, removed, and repaired. According to one example, the plates 128 are sized to not exceed fifty pounds. According to other examples, the plates 128 are sized to weigh one hundred pounds or less.

As illustrated in FIG. 10, each plate assembly 126 includes a second retainer array 132 for attaching each plate assembly 126 onto the first retainer array 112. According to an embodiment, the second retainer array 132 includes a plurality of hooks 134 provided extending from a rear surface 136 of the plate 128. The hooks 134 may be formed from stock steel and welded to the plates 128. The hooks 134 are each pointed downward to hook upon one of the rungs 124 of the first retainer array 112. According to one embodiment, the hooks 134 are also provided in an array of four hooks 134 spaced apart so that each pair of hooks 134 is hung on one rung 124.

The hooks 134 are each formed with a leading edge 138 to engage the rungs 124. The rungs 124 and the leading edges 138 are angled so that during installation, the hooks 134 are slid along the rungs 124, while translating the plate 128 toward the rails 118. Once each plate assembly 126 is slid fully downward, the plate assembly 126 is retained in position and only movable in one direction, by lifting the plate assembly 126 along the leading edge 138. In other words, once a plate assembly 126 is installed, the plate assembly 126 has a limited range of movement relative to the first retainer array 112, and can only be moved by lifting the plate assembly 126. During installation, each plate assembly 126 is held in position by gravity.

As illustrated in FIGS. 9 and 10, each plate assembly 126 is blocked from upward movement, and consequently blocked from removal, by installation of a subsequent sequential plate assembly 126 above the installed plate assembly 126. Once a plate assembly 126 is installed, it blocks the limited range of movement of the plate assembly 126 below it. By blocking a previously installed plate assembly 126, each installed plate assembly 126 provides an obstacle that locks a previous plate assembly 126 for locked retention upon the cone assembly 110, thereby prohibiting inadvertent removal of each previously installed plate assembly 126. The plate assemblies 126 may cooperate by abutment of edges of the plates 128 as illustrated in FIGS. 9 and 10. Alternatively, each plate 128 may overlap a sequential plate 128 in a shingle arrangement.

As illustrated in FIG. 9 each upright array of plate assemblies 126 increases in width as the rails 118 diverge from the intersection 122 to the opening 120. This divergence results in the plate assemblies 126 increasing in size incrementally from the bottom 122 towards the top 120. When a calculated weight of a plate assembly 126 exceeds a target ergonomic threshold, then the plate assemblies 126 are split into a pair of plate assemblies 126 on each pair of rungs 124, thereby separating each upright array of plate assemblies 126 into single plate assemblies 140 and paired plate assemblies 142. According to the depicted embodiment, the uppermost single plate assemblies 140 each include a fastener 144 to fasten the uppermost single plate assemblies 140 to the cone assembly 110. The fasteners 144 lock the uppermost single plate assemblies 140, thereby blocking the lower single plate assemblies 140. Alternatively, the uppermost single plate assemblies 140 may be blocked by the lowermost paired plate assemblies 142.

Each pair of paired plate assemblies 142 blocks a lower sequential pair of paired plate assemblies 142. The uppermost plate assemblies 142 may subsequently be blocked by a block 100 as in the prior embodiment.

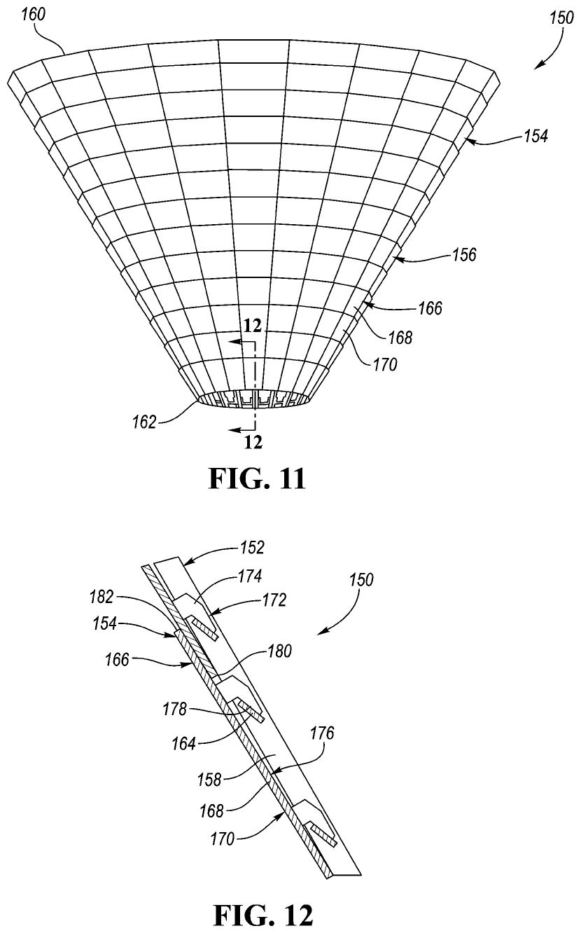

FIGS. 11 and 12 illustrate a cone assembly 150 according to at least one embodiment. With reference now to FIG. 12, the cone assembly 150 includes a first retainer array 152 for attaching a liner assembly 154. The first retainer array 152 is oriented in a radial array around a frustoconical portion 156. The first retainer array 152 includes an array of elongate rails 158 provided around an exterior surface of the frustoconical portion 156, similar to the prior embodiments. The rails 158 may be formed from a stock steel material that is welded to the cone assembly 150. The rails 158 extend from an enlarged opening 160 to an intersection 162 of the frustoconical portion 156 with the outlet 62. Likewise, the rails 158 diverge to the opening 160, and converge toward the intersection 162.

The rails 158 are spaced about the exterior of the frustoconical portion 156 intermittently. The rails 158 may include an alternating spacing with varying widths. The rails 158 each include a common width, depth, and length. A first angular spacing between the rails 158 groups the rails 158 into pairs. A series of rungs 164 is oriented in the first angular spacing between each pair of rails 158. Each pair of rails 158 is spaced apart from a sequential pair of rails 158 by a second angular spacing, which is less than the first angular spacing, and may be provided without rungs 164. The rungs 164 may also be formed from a stock steel material. The rungs 164 may also be welded to the cone assembly 150, and to the rails 158. The rungs 164 have a length extending between the corresponding pair of rails 158. The rungs 164 also have a stock width angled in an upright direction and away from the frustoconical portion 156 with a stock thickness facing upright and outward. The array of first retainers 152 provide an appearance and similarity to an array for tapered ladders. Various retainer arrangements may be employed for attaching components to the cone assembly 150.

Now with reference again to FIGS. 11 and 12, the cone assembly 150 is illustrated with the liner assembly 154. The liner assembly 154 is affixed to the first retainer array 152 to line the exterior of the cone assembly 150 to conceal the cone assembly 150 and protect the cone assembly 150 from abrasion from the particulates passed over the cone assembly 150 during the milling operation. According to the depicted embodiment, the liner assembly 154 is provided by a plurality of plate assemblies 166.

The plate assemblies 166 each include a plate 168. The plate 168 is formed from a steel material. The plate 168 may be flat as depicted thereby collectively providing a funnel shaped liner assembly 154 with flat radial segments. According to another embodiment, the plates 168 are curved to collectively provide a frustoconical liner assembly 154.

Each plate 168 is sized to cover an exterior portion of the frustoconical portion 156 of the cone assembly 150. An exterior surface 170 of each plate 168 is created with a hardened surface 170 to withstand the abrasion during the milling process. According to an embodiment, the hardened surface is a carbide overlay plate. The hardened surface 170 may include a surface weld applied to the exterior surface 170. Alternatively, the hardened surface 170 may be lined, coated, plated, or otherwise applied to the hardened surface 170. According to another embodiment, the plate 168 may be formed as a ceramic tile or another hardened material, such as alloy wear steel.

Each plate 168 is sized to not exceed a predetermined weight. By minimizing the weight of the plates 168, the plate assemblies 166 may be efficiently, safely, and ergonomically installed, removed, and repaired. According to one example, the plates 168 are sized to not exceed fifty pounds.

As illustrated in FIG. 12, each plate assembly 166 includes a second retainer array 172 for attaching each plate assembly 166 onto the first retainer array 152. According to an embodiment, the second retainer array 172 includes a plurality of hooks 174 provided extending from a rear surface 176 of the plate 168. The hooks 174 may be formed from stock steel and welded to the plates 168. The hooks 174 are each pointed downward to hook upon one of the rungs 164 of the first retainer array 152. According to one embodiment, the hooks 174 are also provided in an array of four hooks 174 spaced apart so that each pair of hooks 174 is hung on one rung 164.

The hooks 174 are each formed with a leading edge 178 to engage the rungs 164. The rungs 164 and the leading edges 178 are angled so that during installation, the hooks 174 are slid along the rungs 164, while translating the plate 168 toward the rails 158. Once each plate assembly 166 is slid fully downward, the plate assembly 166 is retained in position and only movable in one direction, by lifting the plate assembly 166 along the leading edge 178. In other words, once a plate assembly 166 is installed, the plate assembly 166 has a limited range of movement relative to the first retainer array 152, and can only be moved by lifting the plate assembly 166. During installation, each plate assembly 166 is held in position by gravity.

As illustrated in FIGS. 11 and 12, each plate assembly 166 is blocked from upward movement, and consequently blocked from removal, by installation of a subsequent sequential plate assembly 166 above the installed plate assembly 166. Once a plate assembly 166 is installed, it blocks the limited range of movement of the plate assembly 166 below it. By blocking a previously installed plate assembly 166, each installed plate assembly 166 provides an obstacle that locks a previous plate assembly 166 for locked retention upon the cone assembly 150, thereby prohibiting inadvertent removal of each previously installed plate assembly 166. Each plate 168 may overlap a sequential plate 168 in a shingle arrangement. By overlapping, a lower end 180 of a plate 168 is slid behind an upper end 182 of a lower plate 168. The overlap provides additional concealment of the cone assembly 150. The lower end 180 also extends above the hooks 174 of the lower plate assembly 166, thereby blocking the hooks 174, and consequently the lower plate assembly 166 from upward movement and disassembly.

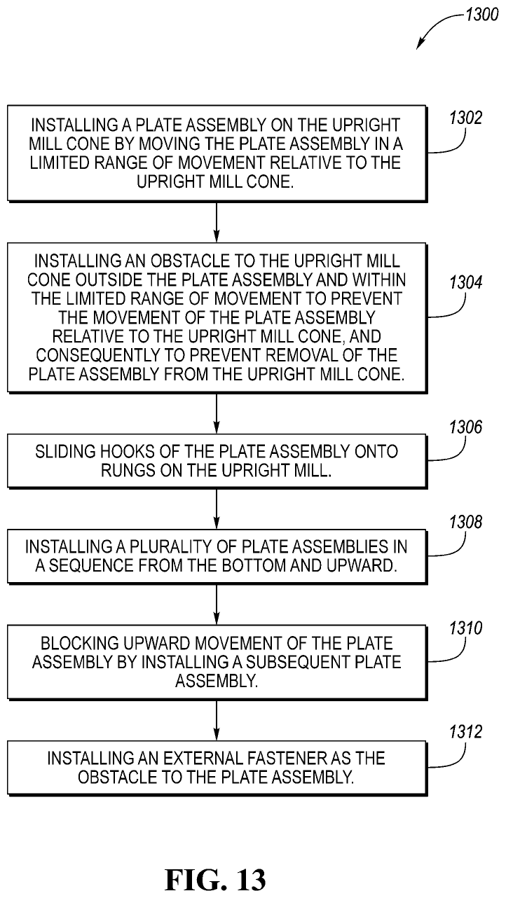

FIG. 13 illustrates a method 1300 to assemble an upright mill cone, according to an embodiment. At step 1302, a plate assembly is installed on the upright mill cone by moving the plate assembly in a limited range of movement relative to the upright mill cone. In block 1304, an obstacle is installed to the upright mill cone outside the plate assembly and within the limited range of movement to prevent the movement of the plate assembly relative to the upright mill cone, and consequently to prevent removal of the plate assembly from the upright mill cone. At block 1306, the hooks of the plate assembly are slid onto rungs on the upright mill cone. A plurality of plate assemblies is installed in a sequence from the bottom and upward in step 1308. During step 1310, upward movement of the plate assembly is blocked by installing a subsequent plate assembly. At block 1312, an external fastener is installed as the obstacle to the plate assembly. Although blocks 1302-1312 are illustrated in combination and sequence, any combination and any sequence of the blocks 1302-1312 is contemplated according to some embodiments.

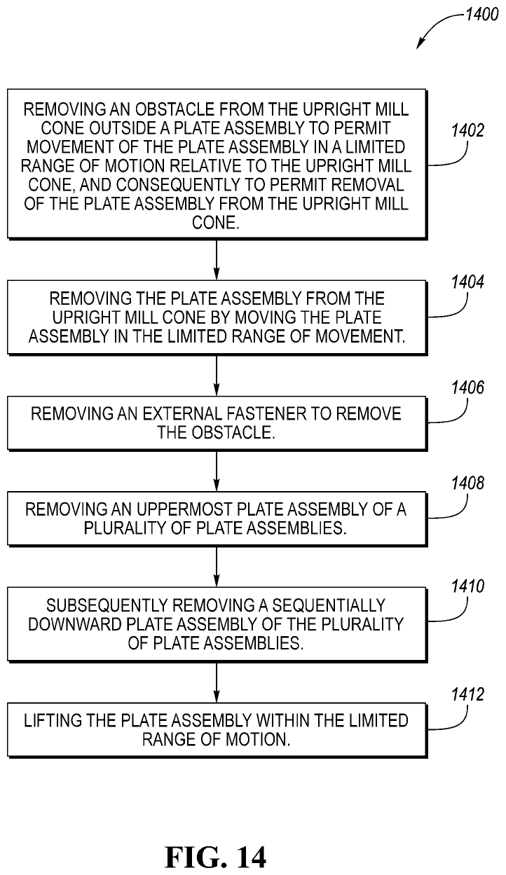

FIG. 14 illustrates a method 1400 to disassemble an upright mill cone, according to an embodiment. In step 1402, the method removes an obstacle from the upright mill cone outside a plate assembly, to permit movement of the plate assembly in a limited range of motion relative to the upright mill cone, and consequently to permit removal of the plate assembly from the upright mill cone. At block 1404, the plate assembly is removed from the upright mill cone by moving the plate assembly in the limited range of movement. During block 1406, an external fastener is removed, to remove the obstacle. Removing an uppermost plate assembly of a plurality of plate assemblies occurs during step 1408. Subsequently a sequentially downward plate assembly is removed during block 1410. At step 1412, the plate assembly is lifted within the limited range of motion. Although steps 1402-1412 are illustrated in combination and sequence, any combination and any sequence of the steps 1402-1412 is contemplated according to some embodiments.

A first clause is provided, alone or in combination with any of the succeeding clauses, with a plate assembly is provided with a plate sized to cover a portion of an upright mill cone. The plate assembly is provided with a retainer to attach the plate to the upright mill cone, wherein upon installation to the upright mill cone, the plate has a limited range of movement relative to the upright mill cone. When a plurality of plate assemblies is installed to the upright mill cone, one of the plurality of plate assemblies is prohibited from movement in the limited range of movement, and thereby prohibited from removal from the upright mill cone.

A second clause is provided, in combination with any of the preceding or succeeding clauses, with the plate provided with a hardened exterior surface to resist abrasion from particulate material within the upright mill.

A third clause is provided, in combination with any of the preceding or succeeding clauses, with the hardened exterior surface is provided with a carbide overlay.

A fourth clause is provided, in combination with any of the preceding or succeeding clauses, with the plate formed from steel.

A fifth clause is provided, in combination with any of the preceding or succeeding clauses, with the plate sized to not exceed a predetermined weight to permit manual installation.

A sixth clause is provided, in combination with any of the preceding or succeeding clauses, with the predetermined weight is fifty pounds or less.

A seventh clause is provided, in combination with any of the preceding or succeeding clauses, with the predetermined weight is one hundred pounds or less.

An eighth clause is provided, in combination with any of the preceding or succeeding clauses, with the retainer provided with at least one hook extending from a rear surface of the plate.

A ninth clause is provided, in combination with any of the preceding or succeeding clauses, with the retainer provided with a plurality of hooks oriented downward.

A tenth clause is provided, in combination with any of the preceding or succeeding clauses, with the plurality of hooks provided with leading edges angled to slide along a rung during installation.

An eleventh clause is provided, in combination with any of the preceding or succeeding clauses, with the limited range of movement as an upright lifting movement.

A twelfth clause is provided, in combination with any of the preceding or succeeding clauses, with the plate assembly retained in position by gravity during operation.

A thirteenth clause is provided, in combination with any of the preceding or succeeding clauses, wherein the plate is flat and forms a radial segment of a frustoconical liner assembly.

A fourteenth clause is provided, in combination with any of the preceding or succeeding clauses, wherein the plate is curved to form part of a frustoconical liner assembly.

A fifteenth clause is provided, in combination with any of the preceding or succeeding clauses, wherein the retainer is welded to the plate.

A sixteenth clause is provided, in combination with any of the preceding or succeeding clauses, wherein the retainer cooperates with a rung to limit motion to a single direction.

A seventeenth clause is provided, alone or in combination with any of the preceding or succeeding clauses, with an upright mill cone assembly provided with an upright mill cone. The upright mill cone assembly is provided with a first retainer array attached to a surface of the upright mill cone and a plurality of plate assemblies, each according to the plate assembly described herein. The plate retainer is operable to attach the plate to the first retainer array, wherein upon installation to the first retainer array, the plate has a limited range of movement relative to the first retainer array. When more than one of the plurality of plate assemblies is installed to the first retainer array, one of the plate assemblies is prohibited from movement in the limited range of movement, and thereby prohibited from removal from the first retainer array.

An eighteenth clause is provided, alone or in combination with any of the preceding or succeeding clauses, with a first retainer array is provided sized to be attached to a surface of an upright mill cone. The first retainer array is sized to receive a plate retainer of a plurality of plate assemblies, wherein upon installation of the plurality of plate assemblies to the first retainer array, a first plate assembly of the plurality of plate assemblies has a limited range of movement relative to the first retainer array. When more than one of the plurality of plate assemblies is installed to the first retainer array, the first plate assembly is prohibited from movement in the limited range of movement, and thereby prohibited from removal from the first retainer array.

A nineteenth clause is provided, in combination with any of the preceding or succeeding clauses, with the first retainer array further provided with a plurality of elongate rails extending along a tapered surface.

A twentieth clause is provided, in combination with any of the preceding or succeeding clauses, wherein the rails diverge toward an upper opening of the upright mill cone and converge toward a lower outlet.

A twenty-first clause is provided, in combination with any of the preceding or succeeding clauses, wherein the rails are operable to be welded to the upright mill cone.

A twenty-second clause is provided, in combination with any of the preceding or succeeding clauses, wherein the first retainer array is further provided with rungs extending between pairs of rails.

A twenty-third clause is provided, in combination with any of the preceding or succeeding clauses, wherein the rungs are angled outward relative to the cone surface.

A twenty-fourth clause is provided, in combination with any of the preceding or succeeding clauses, wherein the rails are grouped into pairs separated by a first angular spacing.

A twenty-fifth clause is provided, in combination with any of the preceding or succeeding clauses, wherein adjacent pairs of rails are separated by a second angular spacing smaller than the first angular spacing.

A twenty-sixth clause is provided, in combination with any of the preceding or succeeding clauses, with each rung sized to support at least two hooks of a plate assembly.

A twenty-seventh clause is provided, in combination with any of the preceding or succeeding clauses, wherein the first retainer array is further provided with a bracket positioned near an upper end of the retainer array.

A twenty-eighth clause is provided, in combination with any of the preceding or succeeding clauses, wherein the first retainer array is further provided with a fastener supported upon the bracket to extend over an uppermost plate assembly.

A twenty-ninth clause is provided, in combination with any of the preceding or succeeding clauses, wherein the fastener is positioned to be outside the plate assemblies.

A thirtieth clause is provided, in combination with any of the preceding or succeeding clauses, wherein the fastener is positioned to block upward movement of the uppermost plate assembly.

A thirty-first clause is provided, in combination with any of the preceding or succeeding clauses, wherein removal of the fastener permits sequential removal of plate assemblies from top to bottom.

A thirty-second clause is provided, alone or in combination with any of the preceding or succeeding clauses, with an upright mill cone assembly provided with an upright mill cone. The upright mill cone assembly is provided with the first retainer array attached to the surface of the upright mill cone and the plurality of plate assemblies. The first plate assembly of the plurality of plate assemblies is provided with a plate sized to cover a portion of the upright mill cone and a second retainer to attach the plate to the first retainer array, wherein upon installation to the first retainer array, the plate has a limited range of movement relative to the first retainer array. When more than one of the plurality of plate assemblies is installed to the first retainer array, one of the plate assemblies is prohibited from movement in the limited range of movement, and thereby prohibited from removal from the first retainer array.

A thirty-third clause is provided, alone or in combination with any of the preceding or succeeding clauses, with an upright mill cone assembly provided with an upright mill cone. The upright mill cone assembly is provided with a first retainer array attached to a surface of the upright mill cone and a plurality of plate assemblies. A first plate assembly of the plurality of plate assemblies is provided with a plate sized to cover a portion of the upright mill cone and a second retainer to attach the plate to the first retainer array, wherein upon installation to the first retainer array, the plate has a limited range of movement relative to the first retainer array. When more than one of the plurality of plate assemblies is installed to the first retainer array, one of the plate assemblies is prohibited from movement in the limited range of movement, and thereby prohibited from removal from the first retainer array.

A thirty-fourth clause is provided, in combination with any of the preceding or succeeding clauses, wherein the first plate assembly is blocked from removal by a second plate assembly of the plurality of plate assemblies positioned above the first plate assembly.

A thirty-fifth clause is provided, in combination with any of the preceding or succeeding clauses, wherein adjacent plate assemblies of the plurality of plate assemblies abut one another.

A thirty-sixth clause is provided, in combination with any of the preceding or succeeding clauses, wherein adjacent plate assemblies of the plurality of plate assemblies overlap in a shingle arrangement.

A thirty-seventh clause is provided, alone or in combination with any of the preceding or succeeding clauses, with a method to assemble an upright mill cone provided by installing a plate assembly on the upright mill cone by moving the plate assembly in a limited range of movement relative to the upright mill cone. The method is provided by installing an obstacle to the upright mill cone outside the plate assembly and within the limited range of movement to prevent the movement of the plate assembly relative to the upright mill cone, and consequently to prevent removal of the plate assembly from the upright mill cone.

A thirty-eighth clause is provided, in combination with any of the preceding or succeeding clauses, wherein the method is further provided with sliding hooks of the plate assembly onto rungs on the upright mill cone.

A thirty-ninth clause is provided, in combination with any of the preceding or succeeding clauses, wherein the method is further provided with installing a plurality of plate assemblies in a sequence from the bottom and upward.

A fortieth clause is provided, in combination with any of the preceding or succeeding clauses, wherein the method is further provided with blocking upward movement of the plate assembly by installing a subsequent plate assembly.

A forty-first clause is provided, in combination with any of the preceding or succeeding clauses, wherein the method is further provided with installing an external fastener as the obstacle to the plate assembly.

A forty-second clause is provided, alone or in combination with any of the preceding or succeeding clauses, with a method of disassembling an upright mill cone by removing an obstacle from the upright mill cone outside a plate assembly to permit movement of the plate assembly in a limited range of motion relative to the upright mill cone, and consequently to permit removal of the plate assembly from the upright mill cone. The method is provided by removing the plate assembly from the upright mill cone by moving the plate assembly in the limited range of movement.

A forty-third clause is provided, in combination with any of the preceding or succeeding clauses, with the method further provided by removing an external fastener to remove the obstacle.

A forty-fourth clause is provided, in combination with any of the preceding or succeeding clauses, with the method further provided by removing an uppermost plate assembly of a plurality of plate assemblies.

A forty-fifth clause is provided, in combination with any of the preceding or succeeding clauses, with the method further provided by subsequently removing a sequentially downward plate assembly of the plurality of plate assemblies.

A forty-sixth clause is provided, in combination with any of the preceding or succeeding clauses, with the method further provided by lifting the plate assembly within the limited range of motion.

A forty-seventh clause is provided with any combination of the preceding clauses.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features, such as various embodiments of the invention.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A plate assembly comprising:
a plate sized to cover a portion of an upright mill cone; and
a retainer to attach the plate to the upright mill cone, wherein upon installation to the upright mill cone, the plate has a limited range of movement relative to the upright mill cone, and wherein, when a plurality of plate assemblies is installed to the upright mill cone, one of the plurality of plate assemblies is prohibited from movement in the limited range of movement, and thereby prohibited from removal from the upright mill cone.

2. The plate assembly of claim 1, wherein the plate comprises a hardened exterior surface to resist abrasion from particulate material within the upright mill cone.

3. The plate assembly of claim 2, wherein the hardened exterior surface comprises a carbide overlay.

4. The plate assembly of claim 1, wherein the plate is formed from steel.

5. The plate assembly of claim 1, wherein the plate is sized to not exceed a predetermined weight to permit manual installation.

6. The plate assembly of claim 5, wherein the predetermined weight is fifty pounds or less.

7. The plate assembly of claim 5, wherein the predetermined weight is one hundred pounds or less.

8. The plate assembly of claim 1, wherein the retainer comprises at least one hook extending from a rear surface of the plate.

9. The plate assembly of claim 1, wherein the retainer comprises a plurality of hooks oriented downward.

10. The plate assembly of claim 9, wherein the plurality of hooks is provided with leading edges angled to slide along a rung during installation.

11. The plate assembly of claim 1, wherein the limited range of movement is an upright lifting movement.

12. The plate assembly of claim 1, wherein the plate assembly is retained in position by gravity during operation.

13. The plate assembly of claim 1, wherein the plate is flat and forms a radial segment of a frustoconical liner assembly.

14. The plate assembly of claim 1, wherein the plate is curved to form part of a frustoconical liner assembly.

15. The plate assembly of claim 1, wherein the retainer is welded to the plate.

16. The plate assembly of claim 1, wherein the retainer cooperates with a rung to limit motion to a single direction.

17. An upright mill cone assembly comprising:
an upright mill cone;
a first retainer array attached to a surface of the upright mill cone; and
a plurality of plate assemblies, each according to claim 1, wherein the plate retainer is operable to attach the plate to the first retainer array, wherein upon installation to the first retainer array, the plate has a limited range of movement relative to the first retainer array, and wherein, when more than one of the plurality of plate assemblies is installed to the first retainer array, one of the plate assemblies is prohibited from movement in the limited range of movement, and thereby prohibited from removal from the first retainer array.

18. A first retainer array sized to be attached to a surface of an upright mill cone, wherein the first retainer array is sized to receive a plate retainer of a plurality of plate assemblies, wherein upon installation of the plurality of plate assemblies to the first retainer array, a first plate assembly of the plurality of plate assemblies has a limited range of movement relative to the first retainer array, and wherein, when more than one of the plurality of plate assemblies are installed to the first retainer array, the first plate assembly is prohibited from movement in the limited range of movement, and thereby prohibited from removal from the first retainer array.

19. The first retainer array of claim 18, further comprising a plurality of elongate rails extending along a tapered surface.

20-32. (canceled)

33. An upright mill cone assembly comprising:
an upright mill cone;
a first retainer array attached to a surface of the upright mill cone; and
a plurality of plate assemblies, wherein a first plate assembly of the plurality of plate assemblies comprises:
a plate sized to cover a portion of the upright mill cone, and
a second retainer to attach the plate to the first retainer array, wherein upon installation to the first retainer array, the plate has a limited range of movement relative to the first retainer array, and wherein, when more than one of the plurality of plate assemblies is installed to the first retainer array, one of the plate assemblies is prohibited from movement in the limited range of movement, and thereby prohibited from removal from the first retainer array.

34-46. (canceled)
